(19) United States
(12) Patent Application Publication
(10) Pub. No.: US 2012/0110897 A1
(43) Pub. Date: May 10, 2012

(54) Biofuel Production

(75) Inventors: John Forrest, Richland, WA (US); Scott Johnson, Hermiston, OR (US); Ramon Benavides, Vero Beach, FL (US)

(73) Assignee: GEN-X ENERGY GROUP, INC., Pasco, WA (US)

(21) Appl. No.: 13/289,618

(22) Filed: Nov. 4, 2011

Related U.S. Application Data
(60) Provisional application No. 61/411,400, filed on Nov. 8, 2010.

(51) Int. Cl. C10L 1/00; B01J 19/18

(52) U.S. Cl. 44/307; 422/187

(57) ABSTRACT

This patent relates to biofuels, such as biodiesel and production of biofuels. One example, introduces a reactant to a renewable feedstock. The example produces a biofuel from the renewable feedstock and separates the reactant from the biofuel. The example recycles the reactant to react with additional renewable feedstock. The example also transfers heat from the recycled reactant to the additional renewable feedstock.

### PRIORITY

This utility application claims priority from U.S. Provisional Application Ser. No. 61/411,400, filed on Nov. 8, 2010, which is incorporated by reference in its entirety.

### BRIEF DESCRIPTION OF THE DRAWINGS

FIGS. 1-2 show examples of systems related to biofuel processing in accordance with some implementations of the present concepts.

FIG. 3 shows a functional example of inventive concepts related to biofuel processing in accordance with some implementations.

FIGS. 4-5 show examples of methods related to biofuel processing in accordance with some implementations of the present concepts.

### DETAILED DESCRIPTION

### Overview

The present description relates to biofuels, such as biodiesel, and production of biofuels. For instance, some type of renewable feedstock can be obtained and various processes can be performed on the feedstock to produce one or more biofuels and in some cases one or more additional products.

The present concepts enable increased energy efficiency associated with biofuel production. For instance, some implementations can produce biofuels utilizing 10% or less of the energy consumed utilizing traditional biofuel production techniques. Further, the present concepts can reduce and/or eliminate the release of green house gases (e.g. molecules) and/or toxic molecules during the biofuel production process.

Examples of several systems are described that can achieve some or all of the present concepts. As used herein the term “system” may be thought of as a “facility” as defined by the United States Environmental Protection Agency (EPA). These systems can be employed in a fixed or stationary setting. Some of these systems also lend themselves to a mobile configuration. For instance some implementations can be manifest in a “skid” configuration that is readily transported by truck, rail, and/or boat. Among other advantages, a mobile configuration allows the system to be moved to a location where the feedstocks are located thereby increasing overall energy efficiency and/or convenience.

Among other techniques, some of the present implementations can achieve energy efficiency by utilizing mechanical vapor recompression (MVR) as part of the waste heat recovery for process heat. Alternatively or additionally, some implementations can achieve efficiency by capturing and recycling reactants, such as methanol.

For example, some implementations can leverage MVR utilizing a precondensing step at a high vacuum. In such cases, the technique can take a first cut at condensing the methanol, decreasing its volume by about 50% and cooling it before it goes to a compressor (e.g., vacuum pump). This can allow a smaller compressor to be employed and can also cool the remaining uncondensed methanol vapor to the inlet temperature requirements of the compressor. Next, the methanol can be compressed, which can provide a heat of compression (which can be harnessed as a heat source). The compression can also raise the pressure of the vapor to a point where any remaining vapor can be more readily condensed since vapors tend to condense better at higher pressure. In this way, these implementations can achieve zero methanol emissions without any refrigeration for condensing. At the same time, the feedstock, which is the cold, condensing fluid, gets heated up and also gets a portion of the methanol reactant it needs to go into the reaction. Thus, this process can be achieved without a refrigeration unit that is required by most or all other biodiesel methanol recovery processes.

The MVR heat can also be adequate to take the reactants to the reaction temperature. Following the reaction (and normal separation of the still methanol-laden fatty acid methyl ester (FAME) and glycerol streams), these techniques can heat the product streams up to a temperature at which the methanol will flash off of them down to a specified methanol content, to meet product quality requirements. In some implementations, the streams can be heated using an “economizer” heat exchanger, in which the outgoing product from the (respective) flash column is crossed with the incoming feed to the flash column. This can heat the feed and cool the product. In some cases, the flashes can be run at vacuum, so the temperature to flash the methanol content down to the specified content is less than it would be at a higher- e.g., atmospheric-pressure. The combination of heat scavenging from MVR and economizers, and running at the lower temperature of the vacuum flash, can lower the energy input to a level where no additional heat input is utilized or where it is economical to use an electric “trim” heater at the flash column inlet instead of a boiler with its attendant direct green house gas (GHG) and criteria emissions.

In summary, some implementations can include: 1) MVR run on vacuum flash; 2) economizers on methanol recovery flash column inputs. Among other potential advantages MVR can recover methanol, and can recover heat. Alternatively or additionally, this type of recovery can greatly reduce and/or eliminate methanol emissions. Further, the present configuration allows methanol to be generally mixed right back into the process. The present concepts can also reduce or eliminate the use of a chiller to condense methanol, lowering capital and operating cost and complexity. Another aspect of the present heat recovery configurations is that the MVR compressor can maintain the vacuum that lowers the required flash temperature. The economizer aspects both recover heat from the finished product and increase safety when handling the finished product. This heat recovery can also eliminate use of a boiler thereby lowering costs, GHGs and criteria emissions.

Some implementations can include a set of one or more condensers. In configurations that utilize multiple condensers, the condensers can be arranged serially in fluid flowing relation and configured to combine liquid reactant methanol (MeOH) with a vegetable oil feedstock and recycled vapor MeOH. Each individual condenser can be configured to operate at a higher pressure than a preceding individual condenser. A reactor can be configured to receive an output from the set of condensers and to produce a biofuel. A flash column can be configured to separate excess vapor phase MeOH from the biofuel and to direct the separated excess vapor phase MeOH as the recycled vapor MeOH to the set of condensers. A set of heat recovery regimes, such as heat exchangers, can be configured to recover heat from the biofuel in an order determined by a reaction temperature of the reactor and a flash temperature of the flash column. For instance, if the flash temperature is higher than the reaction temperature, the biofuel can first be directed to transfer higher quality heat to the biofuel headed to the flash column. Remaining heat can then be transferred to the MeOH and vegetable oil feedstock headed to the reactor. In such a case, the heat recovery regimes can be organized in manner that flows the biofuel in contra-relation to the system flow that produces the biofuel.

### SYSTEM EXAMPLES

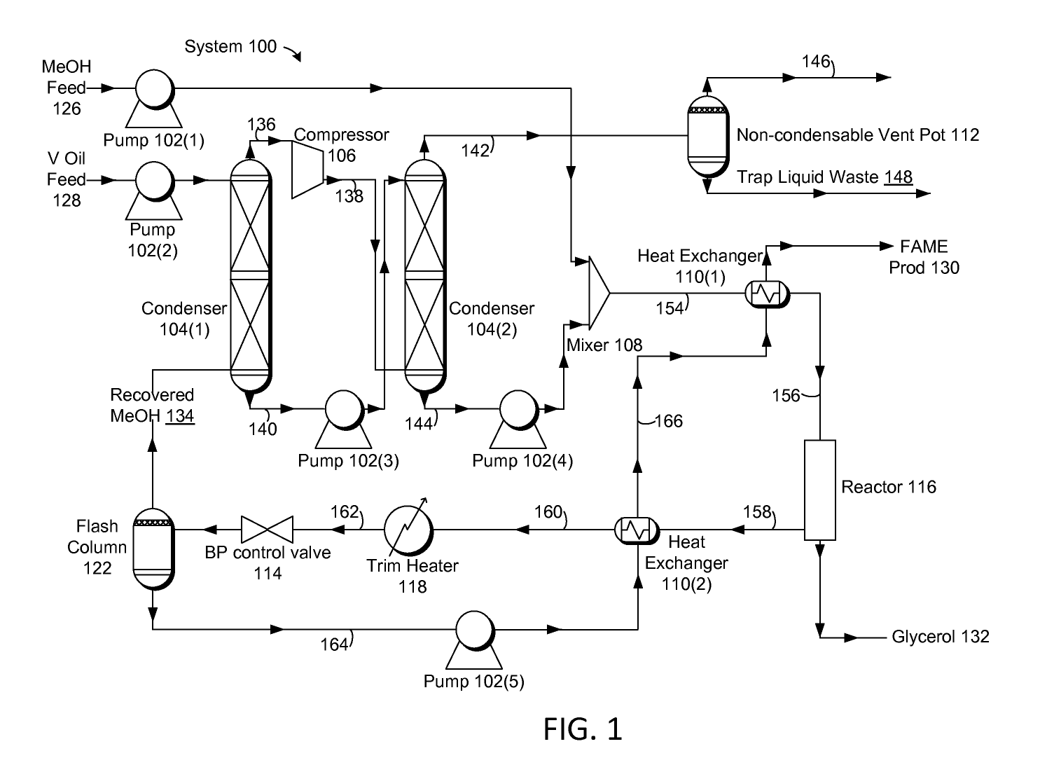

FIG. 1 shows a schematic representation of an example biofuel production system 100. In this case, biofuel production system 100 includes five pumps 102(1)-102(5), two condensers 104(1) and 104(2), a compressor 106, a mixer 108, two heat exchangers 110(1) and 110(2), a non-condensable vent pot 112, a backpressure control valve 114, a reactor 116, a trim heater 118, and a MeOH flash column 122.

System 100 operates by receiving reactants and producing products. For purposes of explanation, the reactants are manifest as MeOH (methanol) or MeOH feedstock 126 and vegetable oil feedstock 128. The products are manifest as fatty acid methyl ester (FAME) biofuel 130, glycerol 132, and recovered MeOH 134 (may also be characterized as recovered excess reactant rather than a product). Stoichiometric moles of vegetable oil feed 128 and the moles of MeOH feed 126 can be determined to produce product FAME and glycerol. Excess moles of MeOH can be utilized, such as 2X, to drive the reaction toward the product FAME and glycerol. Once the system is operating at steady-state, the moles of recovered (from the excess) MeOH 134 can be measured and the moles of MeOH feed 126 supplied to mixer 108 can be reduced by a corresponding amount. The operation of system 100 will be described first at steady-state operations. A start-up procedure is provided after the steady-state description.

Beginning at the upper left of the system 100, condenser 104(1) can be a packed direct contact condenser. The packing serves to increase surface area within the condenser. Alternatively, a separated fluid condenser could be utilized. Pump 102(2) supplies vegetable oil to an upper region of the condenser 104(1). The vegetable oil can flow downward over the packing and coat the packing. The recovered MeOH vapor 134 is supplied to a lower region of the condenser 104(1). The recovered MeOH vapor 134 rises up through the packing in a contra-flow to the vegetable oil 128. The recovered MeOH vapor 134 tends to be hot and have a lot of heat energy. (Specific examples of temperatures of system 100 are described below after the functionality of the components are introduced). The heat energy of the recovered MeOH vapor 134 can be sensible heat and the latent heat of vaporization. The contra-flowing MeOH transfers heat to the liquid vegetable oil 128. A substantial portion of the MeOH gives off enough energy to condense into a liquid and mix with the vegetable oil. Some of the MeOH vapor does not condense, but its temperature decreases as it transfers heat energy to the vegetable oil. This remaining MeOH vapor 136 is drawn from the condenser 104(1) into the compressor 106 where it is compressed. The intake side of the compressor 106 is at partial vacuum (e.g., less than atmospheric pressure) the outlet side of the compressor is at atmospheric pressure or greater.

The compression imparted by compressor 106 heats the remaining MeOH vapor 136 via mechanical vapor recompression. Thus, the compression increases the pressure and the temperature of the output MeOH 138. The output MeOH 138 goes to a lower portion of condenser 104(2).

Vegetable oil/MeOH liquid 140 flowing from the bottom of condenser 104(1) is sent to an upper portion of condenser 104(2) via pump 102(3). This liquid includes vegetable oil feedstock and condensed MeOH. Condenser 104(2) can be a direct contact packed condenser and the liquid 140 flows downward over the packing. Other types of condensers can alternatively be utilized. Recall that the output MeOH 138 entering the bottom portion of condenser 104(2) is at 1.0 atmosphere or above. This vapor phase MeOH tends to condense in condenser 104(2) on to the vegetable oil/MeOH liquid 140. Gas 142 is captured from the top of condenser 104(2). This gas contains very little or no gaseous phase MeOH. Instead the MeOH and vegetable oil mixture 144 drains out of the bottom of condenser 104(2).

Gas 142 is delivered to non-condensable vent pot 112. The vent pot 112 functions to separate non-condensable gases 146, such as air (Nitrogen and Oxygen), from liquid waste 148. The non-condensable gases 146 can be vented through a seal leg to the atmosphere.

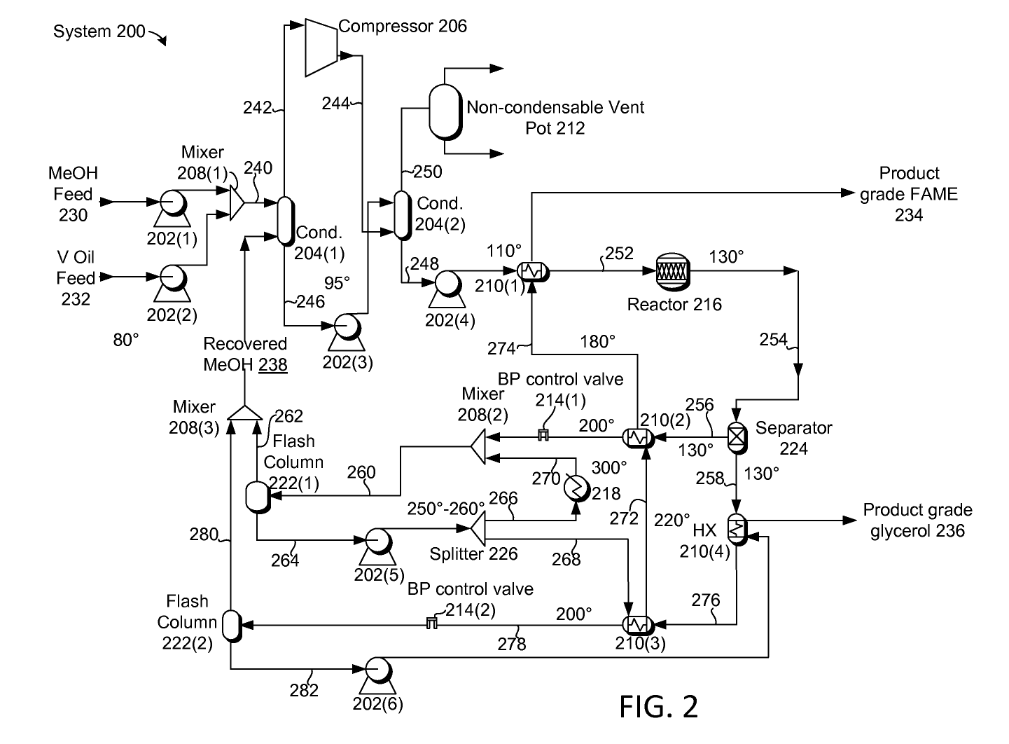

MeOH and vegetable oil mixture 144 is sent from the condenser 104(2) to the mixer 108 by pump 102(4). The mixer 108 can also receive MeOH feedstock 126 from pump 102(1). Mixed feedstocks 154 from the mixer 108 are sent to heat exchanger 110(1). This heat exchanger serves to transfer heat from finished biodiesel product or FAME product 130 to the mixed feedstocks 154. Heated mixed feedstocks 156 are sent to the reactor 116. The reactor produces preliminary FAME 158 and glycerol 132. The term ‘preliminary’ is used here to indicate that this FAME includes excess MeOH. The glycerol 132 leaves the system and is not addressed further in this implementation. However, further processing of the glycerol is discussed below relative to FIG. 2. Also note that the glycerol 132 also tends to contain excess MeOH. This aspect is also discussed relative to FIG. 2.

Preliminary FAME 158 is sent to heat exchanger 110(2). This heat exchanger functions to transfer heat from the FAME product 130 to the Preliminary FAME 158 to produce secondary FAME 160. The secondary FAME 160 can be further heated by trim heater 118 to achieve a defined flash temperature of output tertiary FAME 162. The output tertiary FAME 162 is sent to the flash column 122 via the back pressure control valve 114. Compressor 106 is pulling a vacuum on the flash column and the excess MeOH is flashed off the FAME and pulled out the top of the flash column as recovered MeOH 134. Fame product drains out of the flash column 122 and is directed by pump 102(5) to heat exchanger 110(2), heat exchanger 110(1) and finally out of system 100.

System 100 is now described by way of a working example that illustrates energy savings offered by the present concepts. Beginning again with the upper left hand portion of the system, assume that MeOH feedstock 126 and vegetable oil feedstock 128 are stored at ambient temperature of 70-80 degrees Fahrenheit. Further assume that recovered MeOH 134 is about 250-260 degrees Fahrenheit. The contra-flow offered by condenser 104(1) serves to transfer heat from the recovered MeOH 134 to the vegetable oil feedstock 128. This is useful for multiple reasons. First, some of the recovered MeOH 134 condenses and mixes with the vegetable oil feedstock. Second, the temperature of the vegetable oil has to be raised for the subsequent reaction to occur in reactor 116. In this example, vegetable oil/MeOH liquid 140 leaves condenser 104(1) at about 90-100 degrees Fahrenheit. Third, the temperature of recovered MeOH 134 makes it potentially difficult to process. For instance, a special high-temperature compressor may be needed to handle 250-260 degree materials. By transferring heat energy from the recovered MeOH 134 to the vegetable oil feedstock 128, the temperature of MeOH vapor 136 that actually reaches the compressor can be around 100 degrees and can be handled by readily available compressors. Fourth, the volume of vapor in the form of MeOH vapor 136 that actually reaches the compressor is reduced since some of the MeOH condenses into liquid. Thus, a smaller compressor 106 can be utilized than would otherwise be the case.

The compressor 106 heats the MeOH in the process of compressing the MeOH. As such, output MeOH 138 can be back up to around 180-190 degrees Fahrenheit. However, this output MeOH 138 is now at a higher pressure and is easier to condense. The output MeOH 138 can further heat the vegetable oil/MeOH liquid 140 in the condenser 104(2). As such, MeOH and vegetable oil mixture 144 can leave condenser 104(2) at about 100-120 degrees Fahrenheit. At the higher pressure generated by compressor 106, the MeOH is much more readily condensed and very little (if any) MeOH in the gaseous state leaves the condenser 104(2) in the gas 142.

Now, going out of order, recall that trim heater 118 can supply any additional heat needed to get to the predefined temperature for MeOH flash to occur in tertiary FAME 162. In this example the predefined temperature can be about 250-270 degrees Fahrenheit. This is the value reflected in the recovered MeOH 134 that is obtained from the flash column 122. As such, high temperature FAME 164 that is obtained from the flash column has a similar temperature. This represents both a large amount of potentially wasted energy and a potential danger to workers who might encounter the high temperature FAME 164, such as when transferring the FAME to a truck or other shipping container. Accordingly, high temperature FAME 164 can be run through heat exchanger 110(2) to both lower the temperature of the high temperature FAME 164, but also to use some of that energy to heat the preliminary FAME 158 toward the flash temperature. Thus, the load and the energy consumption of trim heater 118 can be reduced. Intermediate FAME 166 from heat exchanger 110(2) tends to be about 190-200 degrees and is directed to heat exchanger 110(1). As mentioned above sufficient heat tends to remain in intermediate FAME 166 to heat mixed feedstocks 154 up to a predefined reaction temperature for reactor 116. Some configurations can include a controllable bypass around heat exchanger 110(2). In such a configuration, the bypass can ensure that enough heat energy is transferred at heat exchanger 110(1) from the FAME to heated mixed feedstocks 156 to heat the mixed feedstocks to the reaction temperature. A feedback loop from heated mixed feedstocks 156 can allow some or all of the FAME to be directed through heat exchanger 110(2) as long as the reaction temperature is maintained in the heated mixed feedstocks 156. Recall that trim heater 118 is available to heat secondary FAME 160.

Viewed from another perspective, condensers 104(1) and 104(2), compressor 106, and mixer 108 can be thought of as a reactant assembly configured to introduce a reactant (such as MeOH 126) to a renewable feedstock (such as vegetable oil 128). This reactant assembly can also be configured to introduce reclaimed excess reactant (such as recovered MeOH 134) back into the renewable feedstock in a manner that utilizes heat energy of the reclaimed excess reactant to heat the renewable feedstock. Also, MeOH flash column 122 can be thought of as a product separation assembly configured to separate a resultant biofuel from the excess reactant. The flash column 122 can be connected to condenser 104(1) (and subsequently to condenser 104(2)) as a recycle assembly configured to recycle the separated reactant to the reactant assembly. Thus, the recycle assembly in combination with the reactant assembly also functions as a heat transfer assembly configured to transfer heat from the separated reactant to the renewable fuel stock. Another aspect of the heat transfer assembly can be provided by the heat exchangers 110(1) and 110(2).

Start-up of system 100 can be accomplished utilizing various techniques. In one case, piping and valving which is not illustrated can be utilized to allow trim heater 118 to heat the feedstocks to the reaction temperature. In another configuration, system 100 can be filled with biofuel. The biofuel can be input instead of the vegetable oil feedstock 128 and cycled through trim heater 118 until operating temperatures are achieved. Then the system can be switched over to vegetable oil feedstock 128, MeOH feed 126 can be added, and the system can be gradually increased to the rated flow. Start-up can be performed manually or via control circuitry (not shown). The control circuitry can configure the system for start-up and monitor conditions of the system, such as various flow rates and temperatures. The control circuitry can then switch the system to the steady-state configuration based upon the conditions.

The control circuitry can be associated with a computing device. The term “computer” or “computing device” as used herein can mean any type of device that has some amount of processing capability and/or storage capability. Processing capability can be provided by one or more processors that can execute data in the form of computer-readable instructions to provide a functionality. Data, such as computer-readable instructions, can be stored on storage. The storage can include any one or more of volatile or non-volatile memory, hard drives, flash storage devices, and/or optical storage devices (e.g., CDs, DVDs etc.), among others. As used herein, the term “computer-readable media” can include transitory and non-transitory computer-readable instructions. In contrast, the term “computer-readable storage media” excludes transitory instances. Computer-readable storage media includes “computer-readable storage devices”. Examples of computer-readable storage devices include volatile storage media, such as RAM, and non-volatile storage media, such as hard drives, optical discs, and flash memory, among others.

Examples of computing devices can include traditional computing devices, such as personal computers, cell phones, smart phones, personal digital assistants, application-specific integrated circuits ASICs, system-on-a-chip, programmable logic controllers (PLCs), and/or any of a myriad of ever-evolving or yet to be developed types of computing devices.

FIG. 2 shows a schematic representation of an example bio fuel production system 200. In this case, bio fuel production system 200 includes six pumps 202(1)-202(6), two condensers 204(1) and 204(2), a compressor 206, three mixers 208(1)-208(3), four heat exchangers 210(1)-210(4), a non-condensable vent pot 212, two backpressure control valves 214(1)-214(2), a reactor 216, a trim heater 218, two flash columns 222(1) and 222(2), a separator 224, and a splitter 226.

System 200 receives MeOH feedstock 230 and vegetable oil feedstock 232. The products are manifest as fatty acid methyl ester (FAME) biofuel 234, glycerol 236, and recovered MeOH 238 (which may also be characterized as reclaimed excess reactant rather than a product). The operation of system 200 will be described first at steady-state operations. A start-up procedure similar to that described above relative to FIG. 1 can be utilized to get the system up to steady-state operations.

Beginning at the upper left of the system 200, pump 202(1) supplies MeOH feedstock 230 to mixer 208(1). Similarly, pump 202(2) supplies vegetable oil feedstock 232 to mixer 208(1). Mixed MeOH/vegetable oil 240 is supplied to an upper region of condenser 204(1). Recovered MeOH 238 is supplied to a lower region of the condenser 204(1) and contra-flowed with the Mixed MeOH/vegetable oil 240. Any uncondensed MeOH 242 is drawn out the top of the condenser 204(1) and into compressor 206. The compressor pressurizes the received MeOH 242 which is at a partial vacuum to produce pressurized MeOH 244 that is at or above atmospheric pressure. Note that in cases where the ambient temperature (and hence the MeOH feedstock 230 and the vegetable oil feedstock 232) is high, such as above 90 degrees Fahrenheit, a cooler can be installed between condenser 204(1) and compressor 206. This cooler can further reduce the temperature of the MeOH before entering the compressor 206.

Pressurized MeOH 244 is sent to a bottom region of condenser 204(2). Mixed MeOH/vegetable oil 246 is gathered from the bottom of condenser 204(1) and delivered to an upper region of condenser 204(2) by pump 202(3). Mixed MeOH/vegetable oil 248 is obtained from condenser 204(2) and pumped by pump 202(4) to heat exchanger 210(1). Any remaining gases 250 from condenser 204(2) are directed to non-condensable vent pot 212.

MeOH/vegetable oil 248 now includes substantially all (such as >99%) of the recovered MeOH 238 and the heat energy possessed by the recovered MeOH 238. Heat exchanger 210(1) transfers heat to the MeOH/vegetable oil 248 to bring outflowing MeOH/vegetable oil 252 up to a predefined reaction temperature.

The reaction of MeH and vegetable oil occurs in reactor 216 to produce a FAME and glycerol mix 254 that also includes excess MeOH. Separator 224 functions to separate the FAME and glycerol mix 254 into a FAME preliminary stream 256 and a glycerol preliminary stream 258. Both of these preliminary streams include excess MeOH.

FAME preliminary stream 256 goes to mixer 208(2) where it is mixed with returning high temperature finished FAME (described below) into a FAME combination stream 260. The FAME combination stream 260 is delivered to flash column 222(1). The flash column 222(1) functions to separate the FAME from the excess MeOH by flashing the excess MeOH 262 from the remaining high-temperature product-quality FAME 264. The flashed excess MeOH 262 is gathered at the top of flash column 222(1) and delivered to mixer 208(3).

High-temperature product-quality FAME 264 is delivered by pump 202(5) to splitter 226. The splitter sends a portion 266 of the high-temperature product-quality FAME to trim heater 218 and a remainder 268 of the high-temperature product-quality FAME can be thought of as the product stream. The trim heater can heat the portion 266 to produce heated portion 270 that is delivered to mixer 208(2) to be combined with FAME preliminary stream 256. The trim heater can be set on a feedback loop so that it heats heated portion 270 sufficiently so that FAME combination stream 260 is at a predefined temperature. The predefined temperature can relate to the MeOH flash point for proper functioning of flash column 222(1). FAME preliminary stream 256 tends to be at a higher pressure than heated portion 270. Back pressure control valve 214(1) can control the flow of FAME preliminary stream 256 relative to mixer 208(2) to facilitate proper functioning of the mixer.

Remainder 268 of the high-temperature product-quality FAME can be thought of as the product stream. In many cases, the remainder 268 is less than half of the volume of high-temperature product-quality FAME 264. In some cases, 90% of the high-temperature product-quality FAME 264 is directed back to mixer 208(2). Remainder 268 is sent to heat exchanger 210(3). Cooler secondary remainder 272 is emitted from heat exchanger 210(3) and directed to heat exchanger 210(2). Remainder 274 from heat exchanger 210(2) is sent to heat exchanger 210(1). The outflowing remainder from heat exchanger 210(1) is the product grade FAME 234.

Returning now to separator 224 which in addition to the FAME stream discussed above produces glycerol preliminary stream 258. The glycerol preliminary stream 258 is directed to heat exchanger 210(4) and receives heat from ‘finished’ glycerol (introduced below). Outflowing glycerol preliminary stream 276 is then sent to heat exchanger 210(3) where it receives heat from FAME remainder stream 268. Outflowing glycerol preliminary stream 278 can now be hot enough to adequately flash off excess MeOH 280 in flash column 222(2). Now purified, but hot, product grade glycerol stream 282 is directed by pump 202(6) into heat exchanger 210(4). The product grade glycerol stream 282 gives up heat in the heat exchanger to glycerol preliminary stream 258 and becomes product grade glycerol 236. The product grade glycerol stream can meet various specifications, such as those calling for less than two percent remaining MeOH by weight.

Finally, excess MeOH 262 from the FAME stream and excess MeOH 280 from the glycerol stream are drawn into mixer 208(3) and sent to condenser 204(1) as recovered MeOH 238.

System 200 receives rather cool reactants or feedstocks (ambient temperature) and raises the temperature to convert the reactants into products. Further, the products are heated to an even higher temperature for excess MeOH to be separated in flash columns 222(1) and 222(2). System 200 employs several novel configurations to conserve heat energy in the system.

Starting with condenser 204(1), recovered MeOH 238 is received at around 220-240 degree Fahrenheit and mixed MeOH/vegetable oil 240 is received at about 80 degrees Fahrenheit, for purposes of example. Contra-flowing the relatively hot recovered MeOH 238 with the relatively cool mixed MeOH/vegetable oil 240 transfers heat from the hot recovered MeOH 238 to cool mixed MeOH/vegetable oil 240. Further, some of the recovered MeOH 238 condenses and exits the condenser as part of mixed MeOH/vegetable oil 246. Thus, the amount and the temperature of uncondensed MeOH 242 that reaches compressor 206 is reduced. Passing the output (e.g., pressurized MeOH 244) of the compressor into second condenser 204(2) allows essentially all of the recovered MeOH to be recycled and not vented to the atmosphere. Further, the heat energy of the recovered MeOH 238 and any heat energy imparted by the compressor is also recycled into the mixed MeOH/vegetable oil 248 produced by condenser 204(2).

Several heat recycling or recovery aspects are similar to the discussion above relative to FIG. 1. However, in this case, MeOH is recovered from both the FAME stream and the glycerol stream. As such both streams are heated to promote proper functioning of respective flash columns 222(1) and 222(2). In this case, FAME combination stream 260 is delivered to flash column 222(1) at about 260 degrees Fahrenheit to allow for proper flash of the excess MeOH 262. Accordingly, high-temperature product-quality FAME 264 has a temperature of about 260 degrees Fahrenheit. Flash column 222(2) can operate effectively at a temperature of about 200 degrees Fahrenheit so the glycerol (282) that it produces has a similar temperature. Thus, each of these product streams contains a large amount of heat energy that can be recycled by system 200. FAME remainder stream 268 at 250-260 degrees Fahrenheit is the hotter of the two product streams. This stream is first utilized at heat exchanger 210(3) to heat the glycerol preliminary stream 276. The Fame stream (e.g., secondary remainder 272) is then directed to heat exchanger 210(2) to heat the FAME preliminary stream 256. The FAME stream (e.g., remainder 274) is then directed to heat exchanger 210(1) to heat mixed MeOH/vegetable oil 248. At that point, the FAME stream has returned much of its heat energy to the system and can be removed as product grade FAME 234. Viewed from another perspective, the highest quality heat is transferred to the glycerol stream so that the excess MeOH can be flashed from the glycerol without input of additional heat, such as with an electric heater. The next highest quality heat is transferred to the incoming FAME stream to heat it for excess MeOH removal. However, this stream can be augmented with additional heat from the trim heater and so the quality of heat is not as imperative. Finally, sufficient remaining heat can be transferred to the feedstocks at heat exchanger 210(1) to raise the feedstocks to the reaction temperature for reactor 216.

In a similar manner, heat from product grade glycerol stream 282 is transferred to incoming glycerol preliminary stream 258. Thus, the product streams can be thought of as being contra-flowed in heat exchanging relation to the incoming streams in a selective manner that reduces the input of external heat energy.

### FUNCTIONALITY EXAMPLES

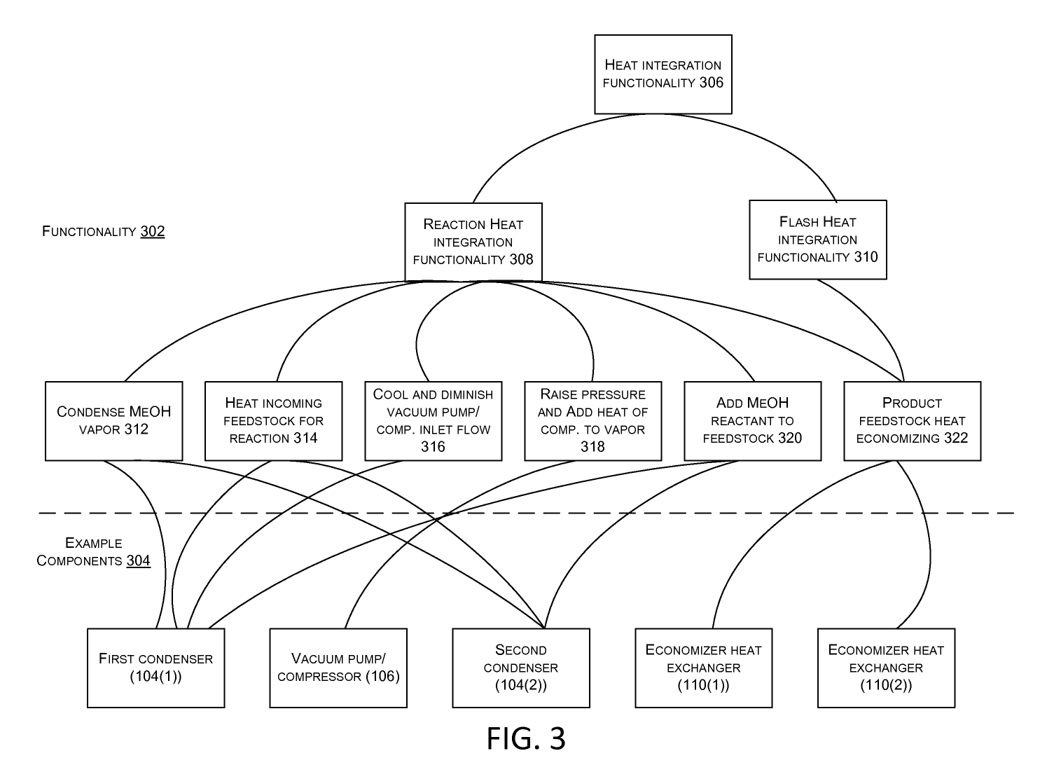

FIG. 3 shows a functional diagram. Novel features are described above in FIGS. 1 and 2 relative to specific structures. FIG. 3 shows some of the novel functionality 302 independent of specific structures or components. For purposes of explanation, but not limitation, FIG. 3 also lists example components 304 for accomplishing the functionality. Alternative structures/components are contemplated, but are not illustrated for sake of brevity. When read in light of the description above and below, the skilled artisan should recognize other structures/components for accomplishing the novel functionalities.

Functional diagram 300 illustrates the functionalities at three levels of granularity. First, at 306 heat integration relative to biofuel production is broken down into reaction heat integration 308 and flash heat integration 310. The reaction heat integration 308 includes six aspects: condensing MeOH vapor at 312, heating incoming feedstock at 314, cooling and diminishing vacuum pump/compressor inlet flow at 316, raising pressure and adding heat of compression to vapor at 318, adding MeOH reactant to feedstock at 320, and product feedstock heat economizing at 322. The flash heat integration 310 can be achieved via the product feedstock heat economizing 322.

Condensing MeOH vapor 312 can be accomplished, for example, with the first condenser 104(1) and the second condenser 104(2). Heating incoming feedstock 314 can also be accomplished with the first condenser 104(1) and the second condenser 104(2), for example. Cooling and diminishing vacuum pump/compressor inlet flow 316 can be accomplished, for example, with the first condenser 104(1). Raising pressure and adding heat of compression to vapor 318 can be accomplished, for example, with the vacuum pump\compressor 106. Adding MeOH reactant to feedstock 320 can be accomplished, for example, with the first condenser 104(1) and the second condenser 104(2). Product feedstock heat economizing 322 can be accomplished, for example, with the first heat exchanger 110(1) and the second heat exchanger 110(2).

### METHOD EXAMPLES

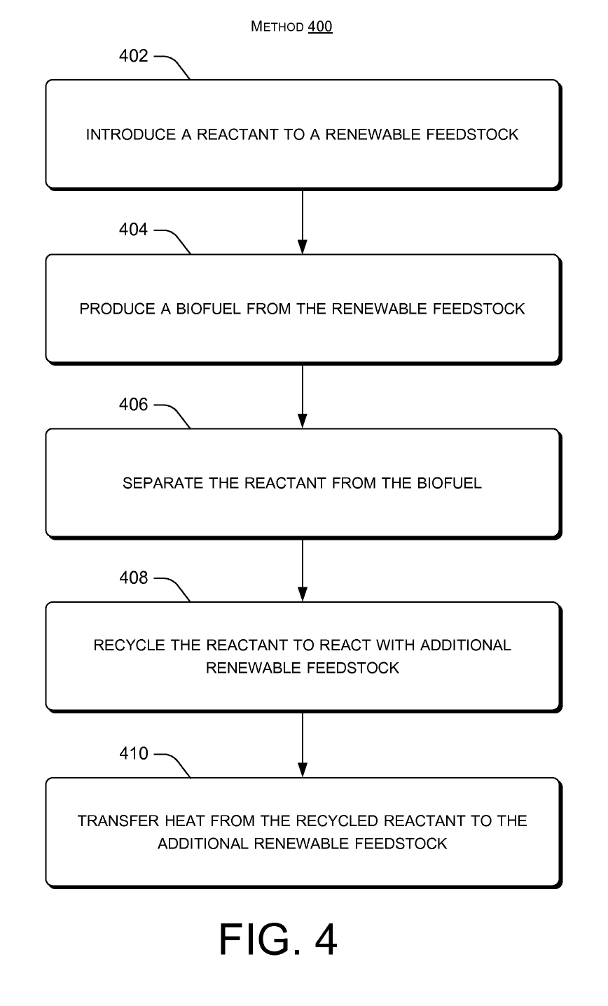

FIG. 4 shows an example biofuel production method 400.

At 402, the method can introduce a reactant to a renewable feedstock. Various alcohols, such as methanol, ethanol, and propanol can function as the reactant. Vegetable oils can function as renewable feedstocks.

At 404, the method can produce a biofuel from the renewable feedstock. For instance, the biofuel can be biodiesel or bioglycerol.

At 406, the method can separate the reactant from the biofuel. For instance, the reactant (e.g., excess reactant) can be flashed off of the biofuel.

At 408, the method can recycle the reactant to react with additional renewable feedstock. In one case, recycling can include introducing the reactant to additional renewable feedstock at a partial vacuum and then re-introducing any remaining reactant at a positive pressure (e.g., at least at atmospheric pressure).

At 410, the method can transfer heat from the recycled reactant to the additional renewable feedstock. The transfer can relate to both temperature and phase change of the recycled reactant.

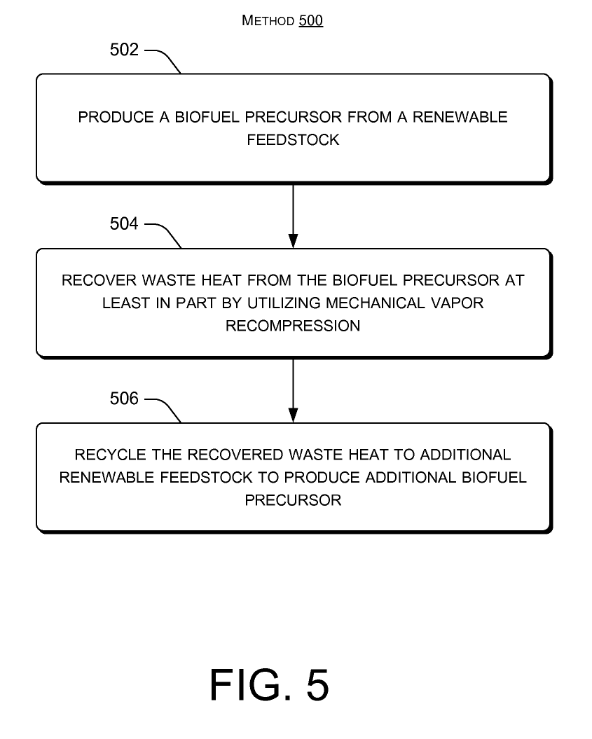

FIG. 5 shows an example biofuel production method 500.

At 502, the method can produce a biofuel precursor from a renewable feedstock. For instance, in an example discussed above, the biofuel precursor is FAME with excess MeOH.

At 504, the method can recover waste heat from the biofuel precursor at least in part by utilizing mechanical vapor recompression. In one case, the excess MeOH is separated from the biofuel precursor to make finished biofuel. The excess MeOH is recycled back into a feedstock to make more biofuel precursor. Some of the waste heat can be transferred to the feedstock in a first contra-flow pass at partial pressure. Any remaining MeOH can be mechanically compressed to a more readily condensable state. The compressed MeOH can then be contra-flowed through the feedstock a second time under positive pressure.

At 506, the method can recycle the recovered waste heat to additional renewable feedstock to produce additional biofuel precursor. In the example described above, heat possessed by the MeOH is transferred to the biofuel precursor. In the above example, this waste heat is utilized to bring the biofuel precursor up to reaction temperature to produce more biofuel (with excess MeOH).

The order in which the example methods are described is not intended to be construed as a limitation, and any number of the described blocks or steps can be combined in any order to implement the methods, or alternate methods. Furthermore, the methods can be implemented manually or automatically in (or by) any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although specific examples of biofuel production systems and methods are described in language specific to structural features, it is to be understood that the subject matter defined in the appended claims is not intended to be limited to the specific features described. Rather, the specific features are disclosed as exemplary forms of implementing the claimed statutory classes of subject matter.

1. A system, comprising:
first and second condensers and a compressor coupled therebetween so that the first condenser operates at a vacuum pressure and the second compressor operates at a positive pressure, wherein the compressor draws excess reactant into the first condenser to contra-flow in direct contact with a feedstock and pushes compressed remaining excess reactant into direct contra-flowing relation in the second condenser with a feedstock mixture obtained from the first condenser such that the remaining excess reactant is condensed into the feedstock mixture;
a reactor configured to receive the feedstock mixture from the second condenser and to output a fatty acid methyl ester (FAME) precursor containing the excess reactant;
a flash column operating at the vacuum pressure and configured to separate the excess reactant from the FAME precursor to produce FAME product; and,
a set of heat recovery regimes configured to recycle heat from the FAME product to the feedstock mixture and the FAME precursor in an order determined by a flash temperature of the excess reactant and a reaction temperature of the feedstock mixture.

2. The system of claim 1, wherein individual heat recovery regimes include heat exchangers.

3. The system of claim 1, wherein the flash temperature is higher than the reaction temperature and the set of heat recovery regimes direct the FAME product first into heat exchanging relation to the FAME precursor and then in heat exchanging relation to the feedstock mixture.

4. A system, comprising:
a set of condensers arranged serially in fluid flowing relation and configured to combine liquid reactant methanol (MeOH) with a vegetable oil feedstock and recycled vapor MeOH, each individual condenser operating at a higher pressure than a preceding individual condenser;
a reactor configured to receive an output from the set of condensers and to produce a biofuel;
a flash column configured to separate excess vapor phase MeOH from the biofuel and to direct the separated excess vapor phase MeOH as the recycled vapor MeOH to the set of condensers; and,
a set of heat recovery regimes configured to recover heat from the biofuel in an order determined by a reaction temperature of the reactor and a flash temperature of the flash column.

5. The system of claim 4, wherein the set of condensers comprises more than two condensers.

6. The system of claim 4, wherein the set of condensers comprises first and second condensers and further comprising a compressor configured to draw a vacuum through the first condenser and to output into the second condenser at positive pressure.

7. The system of claim 4, wherein the set of condensers comprises first, second, and third condensers and further comprising a first compressor serially arranged between the first and second condensers and a second compressor serially arranged between the second and third condensers.

8. A system, comprising:
a reactant assembly configured to introduce a reactant to a renewable feedstock;
a product separation assembly configured to separate a resultant biofuel from the reactant; and,
a recycle assembly configured to recycle the separated reactant to the reactant assembly.

9. The system of claim 8, wherein the reactant comprises methanol.

10. The system of claim 8, further comprising a heat transfer assembly configured to transfer heat from the separated reactant to the renewable feedstock.

11. The system of claim 10, wherein the recycle assembly and the heat transfer assembly are the same assembly or are different assemblies.

12. The system of claim 8, wherein the reactant is introduced in excess amounts and a portion of the reactant is consumed to produce the biofuel and wherein the separated reactant comprises a remainder of the reactant that was not consumed.

13. A method, comprising:
introducing a reactant to a renewable feedstock;
producing a biofuel from the renewable feedstock;
separating the reactant from the biofuel;
recycling the reactant to react with additional renewable feedstock; and,
transferring heat from the recycled reactant to the additional renewable feedstock.

14. The method of claim 13, wherein the introducing comprises introducing the reactant in excess mole quantities relative to the feedstock and the biofuel.

15. The method of claim 14, wherein the separating comprises separating unreacted excess reactant.

16. The method of claim 15, wherein the unreacted excess reactant comprises the excess mole quantities.

17. The method of claim 15, wherein the recycling comprises recycling the unreacted excess reactant.

18. A method, comprising:
producing a biofuel precursor from a renewable feedstock;
recovering waste heat from the biofuel precursor at least in part by utilizing mechanical vapor recompression; and,
recycling the recovered waste heat to additional renewable feedstock to produce additional biofuel precursor.

19. The method of claim 18, wherein the biofuel precursor comprises fatty acid methyl ester (FAME) and glycerol.

20. A system configured to accomplish the method of claim 18.
